(19) United States
(12) Patent Application Publication
(10) Pub. No.: US 2006/0168469 A1
(43) Pub. Date: Jul. 27, 2006

(54) Method and system for correcting program for use in composite video apparatus

(75) Inventors: Jin Whi Kim, Suwon-Si (KR); Young Gi Kwon, Suwon-Si (KR); Jun Hum Hwang, Yongin-Si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/253,605

(22) Filed: Oct. 20, 2005

(30) Foreign Application Priority Data
Jan. 27, 2005 (KR) 2005-7670

(51) Int. Cl. G06F 11/00

(52) U.S. Cl. 714/5

(57) ABSTRACT

A method and system for correcting a program for use in a composite video apparatus can correct a program when an error occurs in a microprocessor including a masked Read Only Memory (ROM). The method and system correct a program of a video apparatus in which a plurality of devices are combined and each device includes a one-chip microprocessor by, if an error occurs in a one-chip microprocessor of either one selected from among the plurality of devices, checking a version of the erroneous one-chip microprocessor, selecting Read Only Memory (ROM) correction data suitable for the version, and correcting a program of the erroneous one-chip microprocessor.

### CROSS-REFERENCE TO RELATED APPLICATION

This application claims the benefit under 35 U.S.C. §119(a) from Korean Patent Application No. 2005-7670, filed on Jan. 27, 2005 in the Korean Intellectual Property Office, the entire disclosure of which is hereby incorporated by reference.

### BACKGROUND OF THE INVENTION

1. Field of the Invention

The present invention relates to a method for correcting a program for use, for example, in a composite video apparatus. More particularly the present invention relates to a method and system for correcting a program for use in a composite video apparatus, which can correct a program when an error occurs in a microprocessor including a masked Read Only Memory (ROM).

2. Description of the Related Art

Generally, a digital video device, such as a DVD player, a VCR, or a camcorder, has been manufactured in the form of a single product. Recently, a composite video apparatus in which at least two devices are integrated in one device has been developed. The above-mentioned composite video apparatus is called a combination system or a combo-system, and may also be referenced as “combo” for short.

There are a variety of combo systems, for example, a DVDP/VCR combo in which a DVDP (DVD Player) and a VCR (Video Cassette Recorder) are combined, and an HDD/DVD recorder in which an HDD and a DVD are combined.

If two devices are implemented with one system as, for example, in the DVDP/VCR combo, each of the two devices requires an independent microprocessor. In other words, the DVDP/VCR combo includes a DVDP microprocessor for controlling functions and operations of the DVDP, and a VCR microprocessor for controlling functions and operations of the VCR.

Each of the DVDP microprocessor and the VCR microprocessor uses a Single One Chip (hereinafter referred to as one chip) semiconductor in which, for example, a CPU (Central Processing Unit), a RAM (Random Access Memory), a ROM (Read Only Memory), a timer, and an A/D (Analog/Digital) converter are integrated in a single IC (Integrated Circuit).

The above-mentioned one chip semiconductor simplifies peripheral components and enhances performance of the peripheral components as compared to a conventional circuit constructed by individual components, such that it is widely used as a requisite component for making a small-sized and lightweight system.

During a fabrication process of the DVDP/VCR combo or after the DVDP/VCR combo has been placed on the market, if there is an error in a program stored in the above-mentioned DVDP/VCR combo or a program version of the DVDP/VCR combo must be updated with a new version, a DVDP set contained in the DVDP/VCR combo simply records new program data in a CD_R, reads the recorded program data using a DVD simultaneously with reproducing the recorded program data, and downloads the read program data in a flash ROM contained in a DVDP area. Therefore, the DVDP set corrects ROM data without being disassembled or assembled, and quickly corrects a program such that an old program is quickly updated with a new program without the loss of components.

However, in the case of the VCR set where the ROM-masked one-chip microprocessor has been installed in the DVDP/VCR combo, although a program encounters an unexpected error or must be updated to a new program, the VCR set is unable to correct the program, whereby a user must disassemble the VCR set and must replace a VCR one-chip microprocessor with a new microprocessor. In this case, the loss of a plurality of components may be sustained, a long period of time is wasted for replacing the one-chip microprocessor with a new microprocessor, experts for microprocessor replacement and verification process for the same are required, and the VCR set may be damaged by an unskilled user during replacement of the microprocessor.

In order to solve the above-mentioned problems, there has been proposed an improved method for recording ROM correction data in a DVDP program if there is an error in the VCR one-chip microprocessor, and upgrading the recorded ROM correction data, such that it can correct contents of a program of the VCR one-chip microprocessor. However, considering the fact that DVDP ROM correction includes correction of contents of the one-chip microprocessor based on an overall version, the above-mentioned improved method may incur system malfunction when erroneous ROM correction occurs in a VCR one-chip microprocessor manufactured in the form of mask products having different versions.

### SUMMARY OF THE INVENTION

Therefore, it is an exemplary aspect of the present invention to provide a method and system for correcting a program for use in a composite video apparatus, which can correct a program without replacing a VCR one-chip microprocessor with a new one when there is an error in the VCR one-chip microprocessor.

It is another exemplary aspect of the present invention to provide a method and system for correcting a program for use in a composite video apparatus, which corrects a program of a VCR one-chip microprocessor by upgrading a DVDP program regardless of version information of the VCR one-chip microprocessor, whereby costs of reworking operations may be reduced.

Additional exemplary aspects and/or advantages of the present invention will be set forth in part in the following description and, in part, may be appreciated, or learned through practice, by skilled artisans from the description of the exemplary embodiments of the present invention.

In accordance with an exemplary aspect of the present invention, the above and/or other exemplary aspects of the present invention can be achieved by the provision of a method for correcting a program of a video apparatus in which a plurality of devices are combined and each device includes a one-chip microprocessor, the method comprising, if an error occurs in a one-chip microprocessor of any one of the plurality of devices, checking a version of the erroneous one-chip microprocessor, selecting Read Only Memory (ROM) correction data suitable for the version, and correcting a program of the erroneous one-chip microprocessor.

In accordance with an exemplary implementation of an exemplary embodiment of the present invention, the checking of the version includes allowing the selected one-chip microprocessor to transmit its version data to the other one-chip microprocessor from among the plurality of devices, and checking version information received from the other one-chip microprocessor.

In accordance with an exemplary implementation of an exemplary embodiment of the present invention, the correcting of the program includes reading ROM correction data from a recording medium in which a correction program is recorded according to the version transmitted from the erroneous one-chip microprocessor, and storing the read ROM correction data in a correction program storage unit.

In accordance with an exemplary implementation of an exemplary embodiment of the present invention, the method further comprises detecting a reset signal of the composite video apparatus, wherein the correcting of the program, if the reset signal is detected, stores ROM correction data for correcting a program stored in the correction program storage unit in a storage unit of the erroneous one-chip microprocessor.

In accordance with an exemplary implementation of an exemplary embodiment of the present invention, the one-chip microprocessor storage unit is pre-assigned an address of a program correction area in which the correction program is to be stored.

In accordance with an exemplary implementation of an exemplary embodiment of the present invention, the correcting of the program includes, if a program counter (PC) of a one-chip microprocessor is equal to an address of an erroneous program area, performing switching to an address of a correction program storage area in which the correction program is stored, and executing the correction program.

In accordance with an exemplary implementation of an exemplary embodiment of the present invention, the method further comprises, after executing the correction program, executing a drive program from the following area other than the erroneous program area, and operating the one-chip microprocessor.

In accordance with another exemplary aspect of the present invention, there is provided a system for correcting a program of a composite video apparatus which includes a plurality of devices including one-chip microprocessors, respectively, stores a drive program in each of the one-chip microprocessors, and controls the plurality of devices, the system comprising a deck unit for reading ROM correction data from a recording medium in which a correction program for correcting a drive program is recorded if an error occurs in a one-chip microprocessor of any one of the plurality of devices; a storage unit for storing the read ROM correction data in an address of a predetermined program correction area, and a controller for executing a correction program stored in the storage unit if a program counter (PC) of the one-chip microprocessor is equal to an address of an erroneous program area.

In accordance with an exemplary embodiment of the present invention, the selected one-chip microprocessor transmits its version data to the other one-chip microprocessor from among the plurality of devices, and receives ROM correction data from the other one-chip microprocessor.

In accordance with an exemplary embodiment of the present invention, the other one-chip microprocessor receives version data from the selected one-chip microprocessor, and transmits ROM correction data suitable for the received version data to the selected one-chip microprocessor.

In accordance with an exemplary embodiment of the present invention, the system further comprises a correction program storage unit for storing the ROM correction data read from the recording medium.

In accordance with an exemplary embodiment of the present invention, the correction program storage unit is a flash ROM, which is installed independently of the one-chip microprocessor and is capable of being updated with new data.

In accordance with an exemplary embodiment of the present invention, the system further comprises a reset sensing unit for detecting a reset of the composite video apparatus, wherein the other one-chip microprocessor, if the reset signal is detected, transmits ROM correction data for correcting a program stored in the correction program storage unit to the erroneous one-chip microprocessor.

In accordance with an exemplary embodiment of the present invention, the selected one-chip microprocessor is a one-chip of a first device, and the other one-chip microprocessor is a one-chip of a second device.

In accordance with an exemplary embodiment of the present invention, the first device is a Video Cassette Recorder (VCR), and the second device is a DVD Player (DVDP).

### BRIEF DESCRIPTION OF THE DRAWINGS

These and/or other aspects and advantages of the exemplary embodiments of the present invention will become apparent and more readily appreciated from the following description of the exemplary embodiments, taken in conjunction with the accompanying drawings in which like reference symbols indicate the same or similar components, wherein:

FIG. 1 is a block diagram illustrating a composite video apparatus according to an exemplary embodiment of the present invention;

FIG. 2 is a conceptual diagram illustrating a method for processing ROM correction data according to an exemplary embodiment of the present invention; and

FIG. 3 is a flow chart illustrating a method for correcting a program of the composite video apparatus according to an exemplary embodiment of the present invention.

### DETAILED DESCRIPTION OF EXEMPLARY EMBODIMENTS

Reference will now be made in detail to the exemplary embodiments of the present invention, examples of which are illustrated in the accompanying drawings, wherein, as noted above, like reference numerals refer to like elements throughout. The exemplary embodiments of the present invention are described below to explain exemplary implementations of the present invention with reference to the drawing figures.

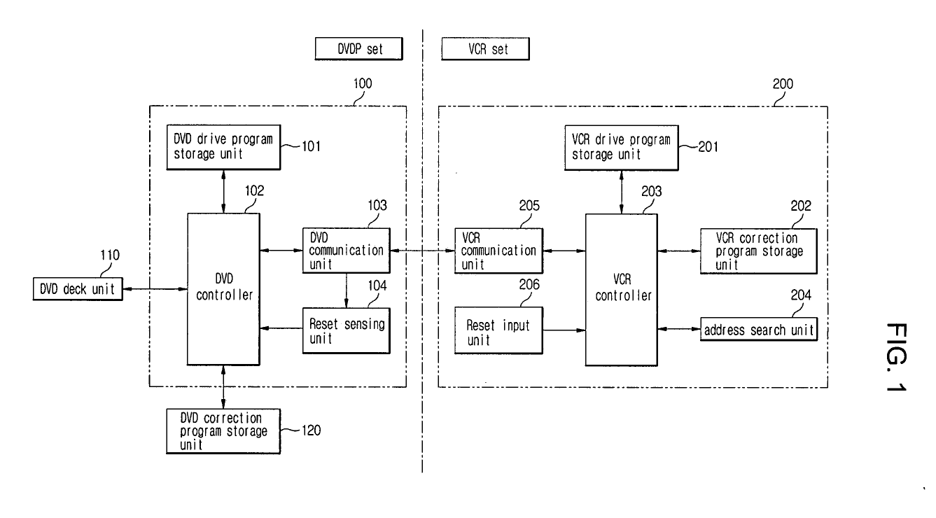

FIG. 1 is a block diagram illustrating a composite video apparatus according to an exemplary embodiment of the present invention. The composite video apparatus shown in FIG. 1 is exemplarily implemented with a DVDP/VCR combination system in which a DVDP acting as a first unit and a VCR acting as a second unit are integrated in one system.

An exemplary embodiment of the present invention discloses a method for correcting a program of the DVDP/VCR combination system without replacing a one-chip microprocessor with a new one, when an error occurs in the program of the DVDP/VCR combination system or there is a need for the program to be updated with a new version.

A DVDP set of FIG. 1 includes a DVD microprocessor 100, a DVD deck 110, and a DVD correction program storage unit 120.

The DVD microprocessor 100 is indicative of an one-chip microprocessor for controlling functions and operations of the DVDP set, and includes a DVD drive program storage unit 101, a DVD controller 102, a DVD communication unit 103, and a reset sensing unit 104.

The DVD drive program storage unit 101 is contained in the DVD microprocessor 100, and stores a drive program for controlling individual components of the DVDP set. The DVD controller 102 controls overall operations of the DVDP set using a DVD drive program stored in the DVD drive program storage unit 101.

The DVD communication unit 103 acts as a serial communication unit for communicating with the VCR set. The DVD communication unit 103 performs serial communication as soon as the VCR is reset, and transmits ROM correction data for VCR correction stored in the DVD drive program storage unit 101 to the VCR set.

The reset sensing unit 104 is adapted to detect a reset operation of the DVDP/VCR combination system. If the VCR set is reset, the reset sensing unit 104 transmits a reset detection signal to the DVD controller 102 by performing serial communication between the VCR set and the DVDP set, such that it informs the DVDP/VCR combination system of the occurrence of the reset signal. If the DVD controller 102 receives the reset detection signal from the reset sensing unit 104, the DVD controller 102 receives ROM correction data for VCR correction from the DVD correction program storage unit 120, transmits the received ROM correction data to the VCR set using serial communication, and stores the ROM correction data in the VCR correction program storage unit 202.

The DVD deck unit 110 reads data recorded in a DVD in order to reproduce the data of the DVD. During a fabrication process of the DVDP/VCR combination system or after the DVDP/VCR combination system has been placed on the market, if an error occurs in a program of the DVDP/VCR combination system or the program must be updated with a new version, the DVD deck unit 110 reads a correction program from a recording medium (such as a DVD) in which a VCR correction program is recorded.

The DVD correction program storage unit 120 stores ROM correction data for VCR correction having been read by the DVD deck unit 110 when there is an error in the VCR drive program stored in the VCR drive program storage unit 201. The DVD correction program storage unit 120 is implemented with an EEPROM (Electrically Erasable and Programmable ROM) or a flash ROM, data of which can be updated with new data. If an error occurs in the VCR drive program after the DVDP/VCR combination system has been placed on the market, the DVD controller 102 detects a reset signal, and transmits the ROM correction data for VCR correction stored in the DVD correction program storage unit 120 to the VCR set using serial communication.

In an exemplary implementation of the present invention, as illustrated in FIG. 1, the DVD correction program storage unit 120 is installed independently of the DVD microprocessor 100, unlike the DVD drive program storage unit 101 which is contained in the DVD microprocessor 100.

The VCR set is configured by implementing a VCR microprocessor 200 for controlling functions and operations of the VCR with a one-chip microprocessor. The VCR set includes a VCR drive program storage unit 201, a VCR correction program storage unit 202, a VCR controller 203, an address search unit 204, a VCR communication unit 205, and a reset input unit 206.

The VCR drive program storage unit 201 is contained in the VCR microprocessor 200, stores a drive program for controlling individual components of the VCR set, and is implemented with a ROM to which a specific address is assigned.

The VCR correction program storage unit 202 stores a VCR correction program. In an exemplary implementation of the present invention, the VCR correction program skips over an erroneous drive program area if there is an error in the VCR drive program stored in the VCR drive program storage unit 201, and is then newly executed. The VCR correction program storage unit 202 is implemented with a RAM, which receives ROM correction data for VCR correction from the DVD correction program storage unit 202 using a serial communication method after the VCR has been reset, and stores the received ROM correction data. In an exemplary implementation of the present invention, the VCR correction program storage unit 202 is contained in the VCR microprocessor 200.

In an exemplary implementation of the present invention, the VCR correction program storage unit 202 pre-determines an address area of the VCR correction program.

If there is an error in the VCR drive program stored in the VCR drive program storage unit 201, the VCR controller 203 skips over an erroneous drive program area, and switches to a VCR correction program stored in the VCR correction program storage unit 202 for controlling the VCR set.

In the case where the address search unit 202 is switched from the VCR drive program stored in the VCR drive program storage unit 202 to the VCR correction program stored in the VCR correction program storage unit 202, and controls the VCR set, the address search unit 202 searches for a VCR correction program address equal to a VCR drive program address.

The VCR communication unit 205 acts as a serial communication unit for communicating with the DVDP set. If communication between the VCR and the DVDP begins, the VCR communication unit 205 transmits version data of the VCR microprocessor 200 to the DVDP set using serial communication.

The reset input unit 206 is adapted to enter a reset signal of the DVDP/VCR combination system. If the VCR set is reset, the reset input unit 205 enters the reset signal in the VCR controller 203, and transmits a reset detection signal to the DVD controller 102 by performing serial communication between the VCR set and the DVDP set.

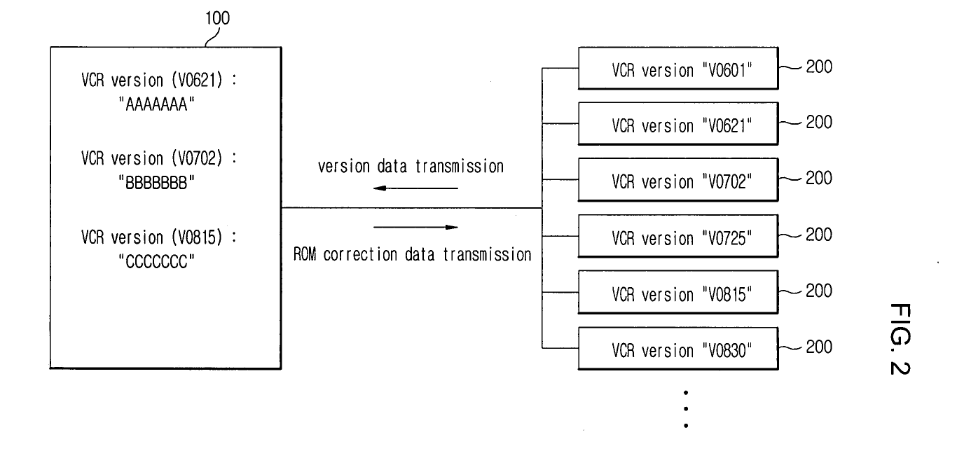

FIG. 2 is a conceptual diagram illustrating an exemplary implementation of a method for processing ROM correction data according to an exemplary embodiment of the present invention.

As shown in FIG. 2, when the DVDP starts communicating with the VCR, the VCR microprocessor 200 transmits its own version data to the DVD microprocessor 100, and receives ROM correction data for VCR correction from the DVD microprocessor 100.

The DVD microprocessor 100 receives the version data from the VCR microprocessor 200, and transmits ROM correction data suitable for the VCR version to the VCR microprocessor 200. If the version transmitted from the VCR microprocessor 200 is not suitable, the DVD microprocessor 100 does not transmit the ROM correction data to the VCR microprocessor 200.

For example, if the VCR version is “V0601”, this means that there is no ROM correction data suitable for the VCR version of “V0601”, such that the DVD microprocessor 100 does not transmit ROM correction data. If the VCR version is “V0621”, the DVD microprocessor 100 transmits ROM correction data of “AAAAAAA” suitable for the VCR version of “V0621” to the VCR microprocessor 200.

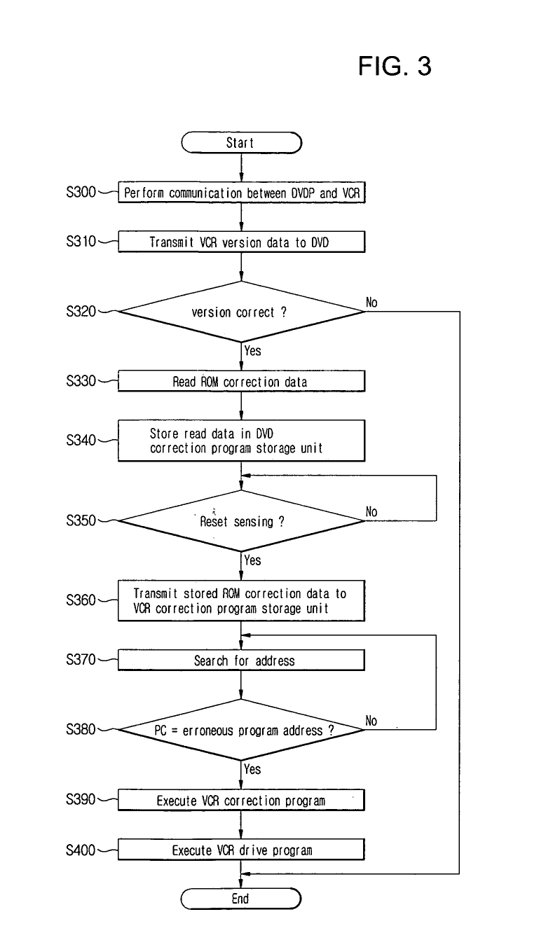

Exemplary operations and effects of the method and system, according to exemplary embodiments of the present invention, for correcting a program of the above-mentioned DVDP/VCR combination system will hereinafter be described with reference to FIG. 3.

FIG. 3 is a flow chart illustrating an exemplary implantation of a method for correcting a program of the composite video apparatus according to an exemplary embodiment of the present invention.

During the fabrication process of the DVDP/VCR combination system or after the DVDP/VCR combination system has been placed on the market, if a program error occurs or a program version-up is required, the DVDP/VCR combination system recognizes a version of the VCR microprocessor 200, records a correction part of a program corresponding to the recognized version in a DVD, and positions the DVD in the DVD deck unit 110.

If the DVDP starts communicating with the VCR at step S300, the VCR microprocessor 200 transmits its version data to the DVD microprocessor 100 using serial communication at step S310.

The DVD microprocessor 100 receives version data from the VCR microprocessor 200, and determines whether the received version data is correct at step S320. If the version data is correct at step S320, the DVD deck unit 110 reads ROM correction data for VCR correction from the DVD positioned therein at step S330.

The read ROM correction data for VCR correction is stored in a predetermined area of the DVD correction program storage unit 120 at step S340.

Thereafter, the reset sensing unit 104 detects a reset signal of the VCR set at step S350. If the reset sensing unit 104 detects the reset signal, the DVD controller 102 transmits the VCR correction program (such as ROM correction data) stored in the DVD correction program storage unit 120 to the VCR correction program storage unit 202 by performing serial communication between the DVDP and the VCR at step S360.

In an exemplary implementation of the present invention, the VCR controller 203 predetermines an address of a program correction area. The address search unit 204 searches for an erroneous drive program address from the VCR drive program storage unit 201, and searches for a program correction area address from the VCR correction program storage unit 202 at step S370.

If the address search unit 204 searches the program correction area address identical with an address of a switching period, the VCR controller 203 determines whether a program counter (PC) is equal to a program address of an erroneous area at step S380.

If the program counter (PC) is equal to the program address of the erroneous area at step S380, the DVDP/VCR combination system jumps to a predetermined program correction area address of the VCR correction program storage unit 202 storing the VCR correction program therein, executes the VCR correction program, and drives the VCR at step S390.

After executing the VCR correction program, the DVDP/VCR combination system jumps to an address area of the VCR drive program storage unit 201 skipping over a program of an erroneous area, executes a VCR drive program from the following area other than the erroneous area, and drives the VCR at step S400.

Therefore, the DVDP/VCR combination system according to an exemplary embodiment of the present invention can correct a VCR drive program without replacing a VCR microprocessor 200 with a new one when an error occurs in the VCR drive program of the VCR microprocessor 200.

Although the exemplary embodiments of the present invention related to a DVDP/VCR combination system in which a DVDP and a VCR are integrated in one system, which is not limited to the DVDP/VCR combination system, but may instead be implemented with a DTV/VCR combination system in which a digital TV (DTV) and a VCR are integrated in one system, and may also be implemented with a variety of combination systems in which at least two devices are integrated in one system.

As is apparent from the above description, exemplary implementations of methods and systems for correcting a program for use in a composite video apparatus according to exemplary embodiments of the present invention can correct a program without replacing a VCR one-chip microprocessor with a new one when there is an error in the VCR one-chip microprocessor, such that it prevents the occurrence of unnecessary time consumption caused by a conventional process during which a user must disassemble the composite video apparatus, must replace a one-chip microprocessor with a new one, and must perform performance verification, and also prevents increased production costs caused by the replacement of components.

Also, according to exemplary embodiments of the present invention, a program of a VCR one-chip microprocessor is corrected by upgrading a DVDP program regardless of version information of the VCR one-chip microprocessor, whereby costs of reworking operations may be reduced.

Although only a few exemplary embodiments of the present invention have been shown and described, it will be appreciated by those skilled in the art that changes and modifications may be made without departing from the principles and spirit of the invention, the scope of which is defined in the claims and their equivalents.

What is claimed is:

1. A method for correcting a program of a video apparatus in which a plurality of devices are combined and each device comprises a one-chip microprocessor, the method comprising:
if an error occurs in a one-chip microprocessor of at least one of the plurality of devices, checking a version of the one-chip microprocessor where the error occurs;
selecting Read Only Memory (ROM) correction data suitable for the version; and
correcting a program of the erroneous one-chip microprocessor.

2. The method according to claim 1, wherein the checking of the version comprises:
allowing a selected one-chip microprocessor to transmit version data thereof to another one-chip microprocessor of at least another one of the plurality of devices; and
checking the version data received in the other one-chip microprocessor.

3. The method according to claim 1, wherein the correcting of the program comprises:
reading ROM correction data from a recording medium in which a correction program is recorded according to the version transmitted from the one-chip microprocessor where the error occurs; and
storing the read ROM correction data in a correction program storage unit.

4. The method according to claim 3, further comprising detecting a reset signal of the video apparatus, wherein the correcting of the program further comprises, if the reset signal is detected, storing the read ROM correction data stored in the correction program storage unit in a storage unit of the one-chip microprocessor where the error occurs.

5. The method according to claim 4, wherein the storage unit comprises a pre-assigned address of a program correction area for storing the correction program.

6. The method according to claim 4, wherein the correcting of the program further comprises:
if a program counter (PC) of the one-chip microprocessor is equal to an address of an erroneous program area, performing switching to an address of a correction program storage area in which the correction program is stored, and executing the correction program.

7. The method according to claim 6, further comprising:
after executing the correction program, executing a drive program from an area other than the erroneous program area, and operating the one-chip microprocessor.

8. The method according to claim 2, wherein the selected one-chip microprocessor comprises a first: one-chip microprocessor of a first device, and the other one-chip microprocessor comprises a second one-chip micropocessor of a second device.

9. The method according to claim 8, wherein the first device comprises a Video Cassette Recorder (VCR), and the second device comprises a DVD Player (DVDP).

10. A system for correcting a program of a composite video apparatus wherein the video apparatus comprises a plurality of devices, at least one of the plurality of the devices comprising a first one-chip microprocessor and at least an other of the plurality of the devices comprising a second one-chip microprocessor, respectively, the video apparatus stores a drive program in at least the first and the second one-chip microprocessors, and the video apparatus controls the plurality of devices, the system comprising:
a deck unit for reading ROM correction data from a recording medium in which a correction program for correcting a drive program is recorded, if an error occurs in either the first or the second one-chip microprocessor;
a storage unit for storing the read ROM correction data in an address of a predetermined program correction area; and
a controller for executing a correction program stored in the storage unit, if a program counter (PC) of either the first or the second one-chip microprocessor is equal to an address of an erroneous program area.

11. The system according to claim 10, wherein:
a selected one of the first and second one-chip microprocessors transmits version data thereof to an other one of the first and second one-chip microprocessors, and the selected one of the first and second one-chip microprocessors receives ROM correction data from the other of the first and second one-chip microprocessors.

12. The system according to claim 11, wherein the other one of the first and second one-chip microprocessors receives version data from the selected one of the first and second one-chip microprocessors, and transmits ROM correction data suitable for the received version data to the selected one of the first and second one-chip microprocessors.

13. The system according to claim 10, further comprising:
a correction program storage unit for storing the ROM correction data read from the recording medium.

14. The system according to claim 13, wherein the correction program storage unit comprises a flash ROM, which is installed independently of either the first or the second one-chip microprocessor and is updatable with new data.

15. The system according to claim 13, further comprising:
a reset sensing unit for detecting a reset of the composite video apparatus,
wherein one of the fist and second one-chip microprocessors, if the reset signal is detected, transmits ROM correction data for correcting a program stored in the correction program storage unit to an other one of the first and second one-chip microprocessors, if an error occurs in the other one of the first and second one-chip microprocessors.

16. The system according to claim 11, wherein the selected one of the first and second one-chip microprocessors comprises a first one-chip of a first device, and the other one of the first and second one-chip microprocessors comprises a second one-chip of a second device.

17. The system according to claim 16, wherein the first device comprises a Video Cassette Recorder (VCR), and the second device comprises a DVD Player (DVDP).
